(19) United States
(12) Patent Application Publication
(10) Pub. No.: US 2003/0033334 A1
(43) Pub. Date: Feb. 13, 2003

(54) Method and system for ascertaining code sets associated with requests and responses in multi-lingual distributed environments

(75) Inventors: Debasish Banerjee, Rochester, MN (US); Kentaroh Noji, Tokyo (JP)

Correspondence Address: IBM Corporation, Intellectual Property Law, Dept. 917, 3605 Highway 52 North, Rochester, MN, 55901-7829, US

(73) Assignee: International Business Machines Corporation, Armonk, NY (US)

(21) Appl. No.: 09/904,734

(22) Filed: Jul. 13, 2001

(51) Int. Cl. G06F 15/00

(52) U.S. Cl. 707/542; 707/536; 709/203

(57) ABSTRACT

A method and apparatus for determining a character set associated with a client request or server response is provided. If the request or response does not specify the character set using the “Content-Type” header, for example, a character set is determined from the locale information. The locale information is mapped to a code set name, which may be contained in a data structure resident on the server. The code set name may be further mapped to a JVM code-set converter.

### BACKGROUND OF THE INVENTION

1. Field of the Invention

The present invention generally relates to the transfer of information over computer networks and more specifically for determining character set information related to an HTTP request and response.

2. Description of the Related Art

In recent years, there has been exceptional growth in the Internet and with electronic commerce (eCommerce) conducted over the Internet. The Internet, originating in the United States, has grown far beyond national borders and has reached every corner of the world and in particular of the World Wide Web (WWW), one of the facilities provided by the Internet.

To use the WWW, a user runs a computer program called a Web browser on a client computer system such as a personal computer. Examples of widely available Web browsers include the Netscape Communicator Web browser available from Netscape Communications Corporation and the Microsoft Internet Explorer provided by Microsoft Corporation. The user interacts with the Web browser to select a particular uniform resource locator (URL). The interaction causes the browser to send a request for the page or file identified by the URL to the server identified in the selected URL. The server responds to the request by retrieving the requested page, and transmitting the data for that page back to the requesting client. The client-server interaction is usually performed in accordance with a protocol called the hypertext transfer protocol (HTTP). The page received by the client is then displayed to the user on a display screen of the client.

WWW pages are typically formatted in accordance with a computer programming language known as hypertext markup language (HTML). Thus, a typical WWW page includes text together with embedded formatting commands, referred to as tags, which can be employed to control, for example, font style, font size, layout, etc. The Web browser parses the HTML script in order to display the text in accordance with the specified format and character set.

A character set is comprised of a list of characters recognized by the server hardware and software and may contain characters specific to a particular written language. Each character is represented by a number and each character set in the HTTP specification is represented by an alpha-numeric representation.

In general, handling character sets by a server involves determining the input character set of a request and the output character set of the response. As an illustration, a servlet (a routine within an application that runs on a web server) or a Java Server Page (JSP) (which is an extension to a Java servlet), is configured to determine the character set of an HTTP request made on a server and which character set will be used by the server when it responds to the HTTP request.

However, there exists no precise mechanism to determine the encoding of character sets in present versions of servlet specifications. Since the Internet conceivably crosses every national border in the world, a server computer must accommodate the plurality of character sets representing the plurality of written languages and dialects used around the world.

Although the HTTP specification includes a “Content-Type” header that may contain character set information, its use is optional. In fact, none of the most popular web browsers presently in use sends a “Content-Type” header containing the character set (charset) attribute. Thus, when a server receives an HTTP request in an unrecognizable character set, it must first convert the character set associated with the request to some universal character set using an inappropriate conversion process. One such universal character set is the Unicode Standard UCS-2 character set. The UCS-2 character set is a character coding system designed to support the worldwide interchange, processing, and display of the written texts of the diverse languages of the world. However, the universal character set may not accurately conform to the actual character set being used by the user. Thus, a client who is sending a request to a server using a character set not recognized by the server may have the request lost by the server or otherwise have the request improperly serviced. Conversely, when a server responds to an HTTP request, the server must also select the proper conversion process to convert the universal character set to a character set recognized by the client.

The problem of determining an input character set and selecting an output character set by a server is well known. Attempts to correct the problem, however, have resulted in piecemeal solutions, some of which are either restricted or incorrect. For example, Tomcat 3.x, Sun Microsystem's official reference implementation of Servlet 2.2 and JSP 1.1 specifications, looks for the “charset” attribute contained in the “Content-Type” header which may be present in an HTTP request, and if it finds none, sets the character set to the default HTTP standard ISO-8859 code set. This essentially restricts Tomcat to correctly process input requests encoded only in the ISO-8859-1 code set where no recognizable character set is specified.

Another prior art method first determines if a server has defined a default code-set. If so, the prior art method will use that code-set, thereby restricting the prior art method to work only in those environments which process only one code-set.

When the server formulates a response to the HTTP request, the output code set determination implemented by Tomcat and other prior art is likewise restricted. The code-set selection information is contained in hard-coded tables in the Servlet code and cannot be tailored to suit specific installations.

Therefore, there is a need for a software mechanism for a server computer that can identify the character set associated with a user request. There is also a need for a software mechanism that can easily accommodate the growing list of worldwide character sets and is user configurable.

### SUMMARY OF THE INVENTION

The embodiments generally relate to the transfer of information over computer networks and in particular to the transfer of information between a client and server computer. In a particular embodiment, a method of ascertaining code sets associated with HTTP requests and responses in multi-lingual environments is provided.

In one embodiment, a method and system is provided for determining a character set associated with a client request. The method determines if the request designates a character set. If no character set is designated, the method retrieves locale information that is contained in the request. The locale information is then associated with a character set by accessing a locale-to-character set look-up table. The character set is further associated with a code-set converter, if one is available, to further define the character set by accessing a character set-to-code-set converter look-up table.

In another embodiment, a computer readable medium is provided which contains a program which, when executed, performs the foregoing method for determining a character set associated with a client request.

In another embodiment, a method and system is provided for determining a character set associated with a server response. The method first determines if the response designates a character set. If no character set is designated, the method retrieves locale information from a locale parameter contained in a servlet. The locale information is then associated with a character set by accessing a locale to character set look-up table. The character set is further associated with a code-set converter, if one is available, to further define the character set by accessing a character set to code-set converter look-up table.

In another embodiment, a computer readable medium is provided which contains a program which, when executed, performs the foregoing method for determining a character set associated with a response.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a block diagram of a computer system consistent with the invention.

FIG. 2 illustrates a locale to character set look-up table.

FIG. 3 illustrates a character set to JVM converter look-up table.

FIG. 4 is a flow chart illustrating the method for determining the character set of an HTTP request.

FIG. 5 is a flow chart illustrating the method for determining the character set of an HTTP response.

### DETAILED DESCRIPTION OF THE PREFERRED EMBODIMENT

The present invention generally provides a method, apparatus and article of manufacture for a server computer, in a distributed computer network, to identify the code set associated with an HTTP request from a client computer. In one embodiment, the code set associated with an HTTP request is determined by a heuristic method. The heuristic method locates the code set by searching a table of character sets using locale information contained in the HTTP header. In another embodiment, the output code set associated with a response to an HTTP request is determined by the heuristic method. In still another embodiment, a code set that is identified by the heuristic method is further associated with a JVM (Java Virtual Machine) converter.

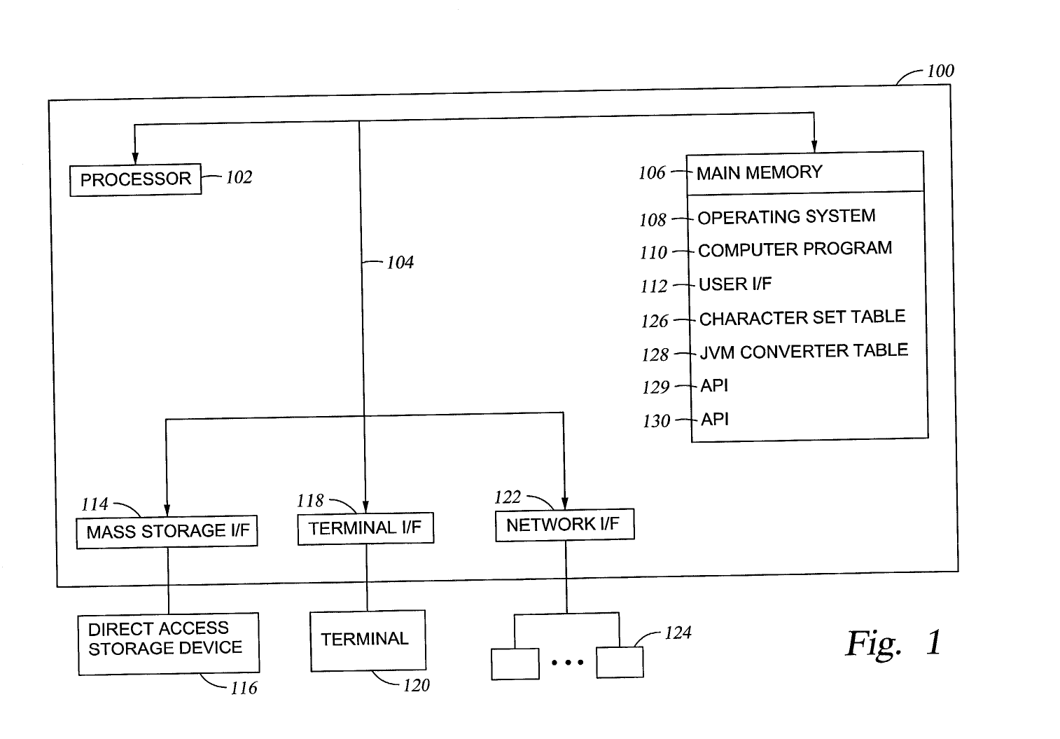

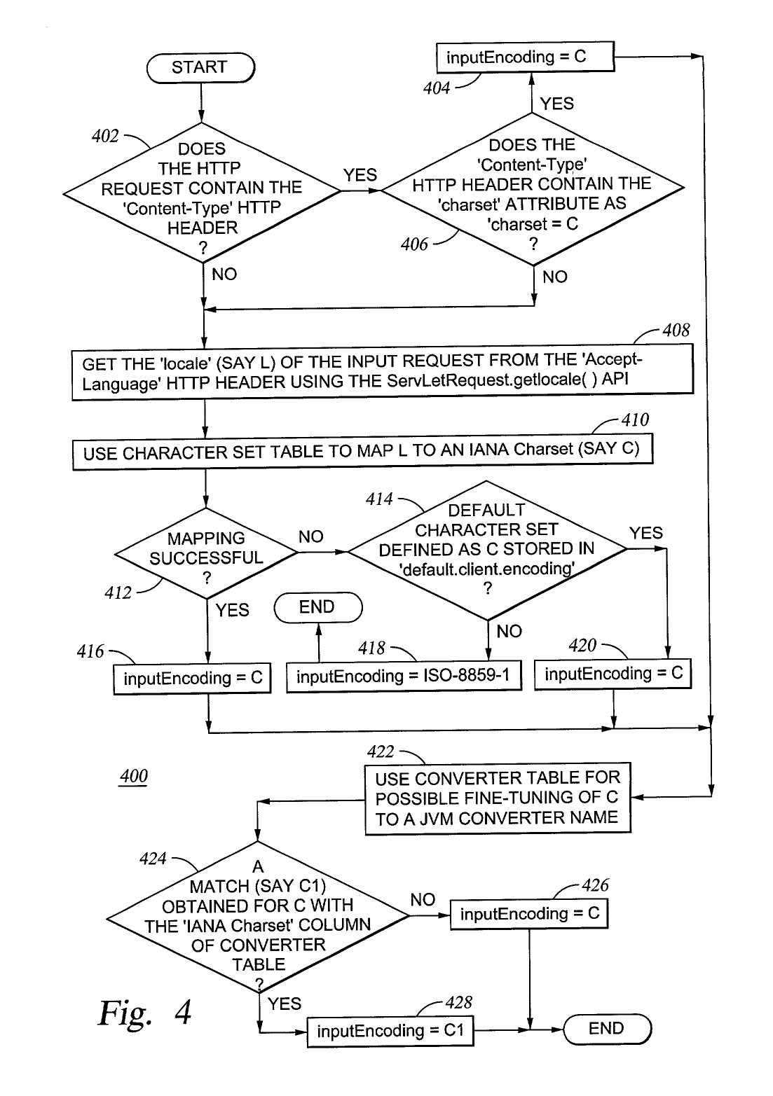

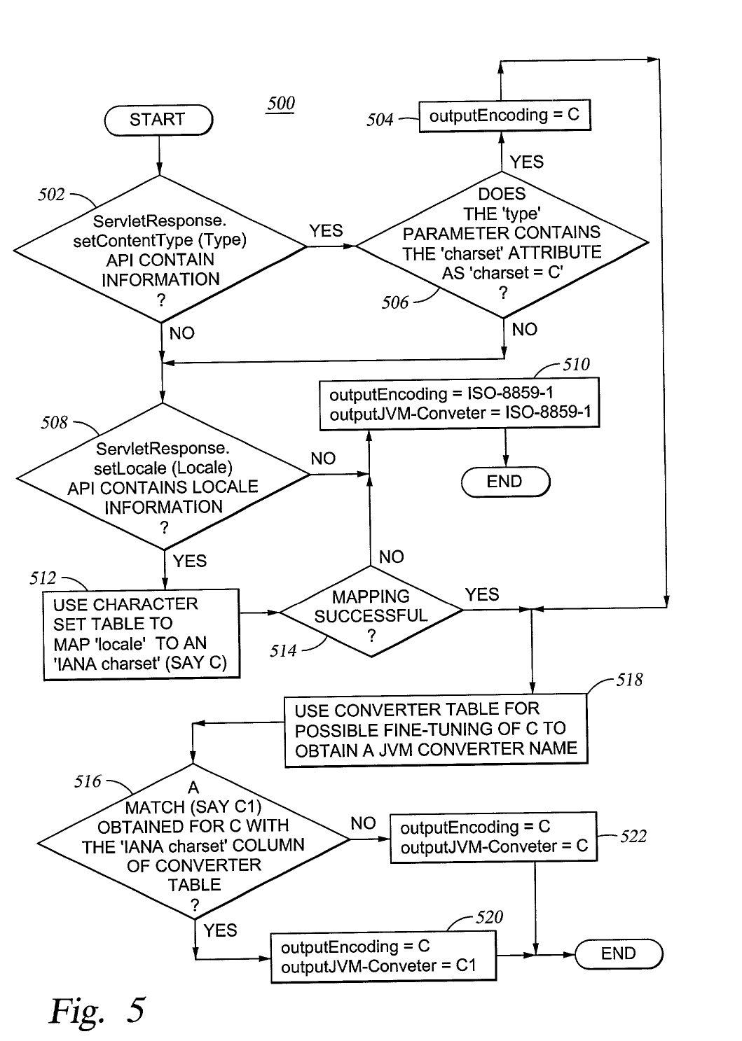

One embodiment of the invention is implemented as a program product for use with a server computer system such as, for example, the server computer system 100 shown in FIG. 1 and described below. The program(s) of the program product defines functions of the embodiments (including the methods described below with reference to FIGS. 4 and 5) and can be contained on a variety of signal/bearing media. Illustrative signal/bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. In addition, programs are comprised of variables and data structures that either reside locally to the program or are found in memory or on storage devices.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. Furthermore, the terms code-set, encoding, character set, and “charsef” have the same meaning herein and are used inter-changeably.

In a particular embodiment, the code-set program 110 is implemented as a Java program. However, the particular program language is not germane to embodiments of the invention and is therefore not considered limiting. In other embodiments, languages such as C++, Object Pascal, Smalltalk, Pascal, C, Basic, COBOL and the like may be used to implement the code-set program 110.

FIG. 1 is an illustration of a server computer system 100 shown for a multi-user programming environment that includes at least one processor 102, which obtains instructions and data via a bus 104 from a main memory 106. The processor 102 can be any processor adapted to support the methods described below. Illustratively, the processor is a PowerPC available from International Business Machines of Armonk, N.Y. In a particular embodiment, the server computer system 100 is a WebSphere® application server configured with the code set selection mechanisms described herein. WebSphere® is available from International Business Machines of Armonk, N.Y.

The main memory 106 includes an operating system 108, a code-set computer program 110, a user interface program 112, a character set table 126, a JVM (Java Virtual Machine) converter table 128, an application programming interface (API) 129 and an API 130. The main memory 106 could be one or a combination of memory devices, including Random Access Memory, nonvolatile or backup memory, (e.g., programmable or Flash memories, read-only memories, etc.) and the like. In addition, memory 106 may be considered to include memory physically located elsewhere in a computer system 100, for example, any storage capacity used as virtual memory or stored on a mass storage device or on another computer coupled to the computer system 100 via bus 104.

The computer system 100 is coupled to a number of operators and peripheral systems. Illustratively, these include a mass storage interface 114 operably connected to a direct access storage device 116, a input/output (I/O) interface 118 operably connected to I/O devices 120, and a network interface 122 operably connected to a plurality of networked devices 124. The I/O devices may include any combination of displays, keyboards, track point devices, mouse devices, speech recognition devices and the like. In some embodiments, the I/O devices are integrated, such as in the case of a touch screen. The networked devices 124 could be displays, desktop or PC-based computers, workstations, or network terminals, or other networked computer systems. It is contemplated that the computer system 100 is connected to the networked devices 124 via a local area network (LAN) or a wide area network (WAN), such as the Internet. As such, one of the networked devices 124 is a client computer configured with a Web browser program capable of requesting and receiving information from the computer system 100.

In operation, the computer program 110 is executed to handle requests and responses with respect to the networked devices 124. In general, a request is received and parsed to determine the presence of a code-set identifier indicating a specific character set. In the case of an HTTP request, such a determination is made by analyzing the content of a “Content-Type” header. Table 1 illustrates an HTTP header from an HTTP request generated by the Microsoft Internet Explorer Version 5.5 web browser.

TABLE 1

| | |
|---|---|
| 001 | GET /servlet/sample HTTP/1.1 |
| 002 | Accept: */* |
| 003 | Accept-Language: ja,ko;q=0.7,en-us;q=0.3 |
| 004 | Accept-Encoding: gzip, deflate |
| 005 | User-Agent: Mozilla/4.0 (compatible; MSIE 5.01; |
| | Windows NT 5.0) |
| 006 | Host: dtco02.yamato.ibm.com |
| 007 | Connection: Keep-Alive |
| 008 | Cookie: w3ibmTest=true; sdluser2=nken; msp=2 |

Line 001 indicates the HTTP protocol version used by the client. Lines 002 and 004 specify the media type and content-codings acceptable to the client. Line 003 indicates that the client intends to accept web documents in Japanese (ja), Korean (ko), or American-English (en-us) languages. Line 003 also indicates the language preference order of the client; in this particular example, the ordering is Japanese first, followed by Korean; American-English being the last choice. Lines 005 and 006 contain information relating to the software version of the Web browser used by the client, the operating system used by the client, and the target internet host name. Line 007 specifies the option for a particular connection. Line 008 shows the ‘cookie’ values that this particular client wants to send on every request.

If the “Content-Type” header is missing from an HTTP request, or if the “Content-type” header does not contain a code-set identifier, the computer program 110 determines the locale of the HTTP request by invoking an Application Programming Interface (API) 129 configured to extract the locale from the HTTP request. One API which may be used to advantage is the ServletRequest.getLocale( ) API developed by Sun Microsystems. If the Accept-Language HTTP input header contains the most preferred cultural setting of the client, the API 129 returns that cultural preference. Otherwise, it returns the server's locale as the default. The computer program 110 selects the appropriate character set associated with the locale identifier returned by the API 129.

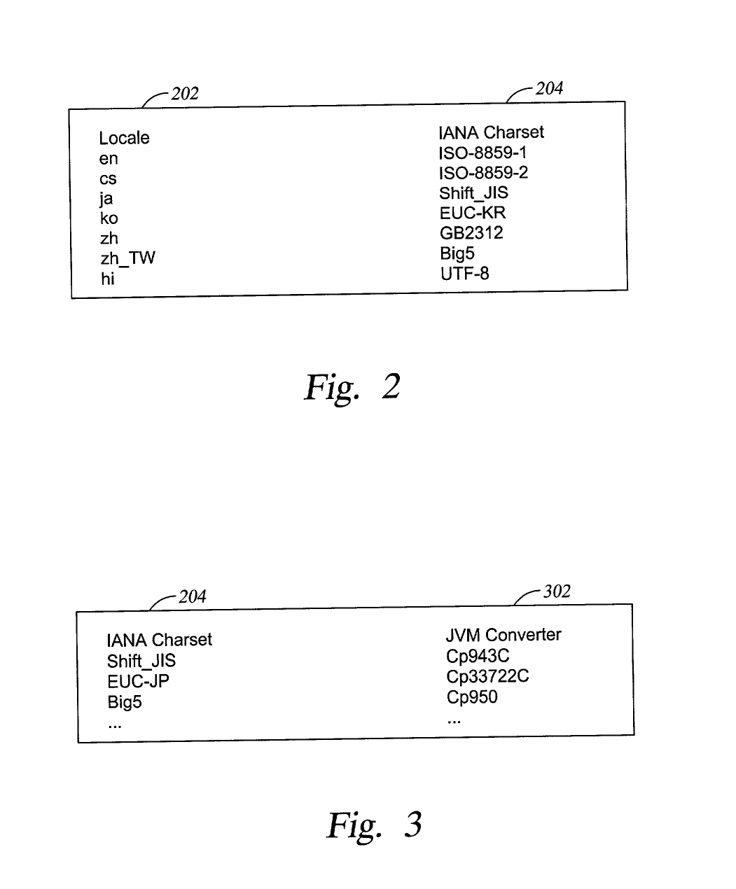

FIG. 2 illustrates one embodiment of the character set table 126 comprising locale information 202 and IANA (Internet Assigned Numbers Authority) character sets 204. Illustratively, the input locale information 202 on the left side of the table is mapped to an IANA character set 204 on the right side of the table. The locale information 202 contains information relating to a user's cultural language preference and may be denoted as an abbreviated language identifier. In this example, “en” is an abbreviation denoting that the user is located in an English language locale. Further, “cs” denotes a Czechoslovakian locale and “ja” a Japanese locale. In this example, the English (en) language locale is mapped to the IANA character set ISO-8859-1. The locale information 202, which is returned by the API 129, is mapped to an IANA character set in IANA character set 204, and this character set will then be associated with the HTTP request. The “Content-Type” header may contain information relating to the user's IANA character set (charset) information 204. If the “Content-Type” header contains any information at all, it is next determined if the header contains IANA character set information. If IANA character set information is provided, it may be desirable to locate a converter for the IANA character set information using the JVM (Java Virtual Machine) converter table 128.

FIG. 3 illustrates one embodiment of the JVM (Java Virtual Machine) converter table 128 which maps IANA character sets 204 with a JVM (Java Virtual Machine) converter 302. The JVM converter 302 further defines an IANA character set 204 to accommodate vendor implementations of character sets and UCS-2 universal character set conversion routines. As an illustration, in some language environments, the official IANA character set names may have more than one code set converter associated with them. For example, the most popular code set in Japanese PC environments is “Shift_JIS”, and there exists a large number of “Shift_JIS” converters. Furthermore, the Java Development Kit (JDK), a software development kit for producing Java programs, supports the Cp943, Cp943C, Cp942, Cp942C, SJIS and MS932 converters. All of these converters are associated with the UCS-2 universal character set to Shift_JIS code set conversions and from Shift_JIS to UCS-2 conversions.

In one embodiment, both the character set table 126 and the converter table 128 are user configurable. That is, a system administrator or similar operator may configure the mappings of each table, thereby avoiding the need to reprogram the underlying code. To this end, the tables 126 and 128 may be exposed as Java property files or preference files readily accessible by the system administrator.

One embodiment illustrating a method for identifying a code-set associated with an HTTP request is shown as a method 400 in FIG. 4. At step 402, the method queries if the HTTP request contains the “Content-Type” HTTP header. If the input request does contain the HTTP header, the method 400 proceeds to step 406 where the method queries if the HTTP header contains IANA character set 204 “charset” attributes. In this example, the method queries if the character set equals “C” (charset=C) though a character set may be identified by any alphanumeric combination. If so, the method 400 proceeds to step 404 where the “C” character set is then associated with the HTTP request and then proceeds to step 422. The code listing of computer program 110 shown in Table 2 illustrates one example of determining if the HTTP header contains IANA character set information 204.

TABLE 2

| | |
|---|---|
| 001 | if isPresent(“Content-Type”) |
| 002 | { |
| 003 | if “Content-Type” contains the String “charset=C” |
| 004 | inputCodeSet = “C” |
| 005 | } |

At line 001, the “if” statement tests if “Content-Type” information is present in the HTTP header. At line 003, the “if” statement tests whether the “Content-Type” information contains IANA character set information 204. In this example, the code is testing if the IANA character set information 204 “charset” is set to the “C” character set. If the test is positive, the code set associated with the input request is set to the “C” character set at line 004. If the “Content-Type” HTTP header does not contain character set information, the method 400 proceeds to step 408.

At step 408, the method 400 retrieves the locale information 202 of the HTTP request that is stored in the “Accept-Language” HTTP header using the API 129. The “Accept-Language” parameter, which is defined in the HTTP protocol, may contain user locale information 202. At step 410, the method 400 searches the locale information 202 illustrated in FIG. 2 to find a match with the locale information returned by the API 129. At step 410, if a match was found, the method 400 accesses the table 126 illustrated in FIG. 2 to map the matched locale to an IANA character set 204. At step 412, the method 400 queries if a mapping of the locale 202 to the IANA character set 204 was successful. If not, the method 400 proceeds to step 414.

At step 414, the method 400 queries if a default character set for the server 100 has been declared and stored in the “default.client.encoding” JVM system property in computer program 110. If so, the method 400 proceeds to step 420 where the default character set is then associated with the HTTP request and then proceeds to step 422. If no default character set was declared, the method 400 proceeds to step 418 where the HTTP request is set to the HTTP protocol default character set, for example the ISO-8859-1 character set.

If, at step 412, the mapping of the locale information 202 to an IANA character set 204 information was successful, the method 400 proceeds to step 416 where the HTTP request is then associated with the mapped IANA character set. The method 400 then proceeds to step 422 where the method 400 accesses the JVM converter 302 information illustrated in FIG. 3 to find a match with the IANA character set 204. At step 424, the method 400 queries if a match with a JVM converter 302 was obtained. If so, the method 400 associates the matched JVM converter with the HTTP request as its input code set at step 428. If not, the method 400 then associates the HTTP request with the IANA character set 204.

As an illustration, once an appropriate code-set has been associated with an HTTP request, the computer program 110 will then convert the request to the Unicode Standard (UCS-2) character set using a JVM converter. The Unicode Standard is a character coding system designed to support the worldwide interchange, processing, and display of the written texts of the diverse languages in the world. The Unicode Standard is known in the art and is maintained by the Unicode Technical Committee.

One embodiment illustrating a method for selecting a code-set associated with an HTTP response is shown as a method 500 in FIG. 5. At step 502, the method 500 queries if the API 130 contains information. One such API known in the art, is the ServletResponse.setContentType( ) API, developed by Sun Microsystems. Illustratively, the API 130 includes a servlet, or routine within the computer program 110, to provide an HTTP “Content Type” header for the HTTP response. The HTTP “Content-Type” header may contain information including but not limited to character set attributes. In one embodiment, such information is stored in the ServletResponse.setContentType( ) API string parameter. If at step 502 the query is answered in the affirmative, the method 500, at step 506, queries if the string parameter contains the “charset” attribute set as “charset=C”, for example. If so, the method 500 proceeds to step 504 where the “C” character set is then associated with the HTTP response and then proceeds to step 518. If not, the method 500 proceeds to step 508.

At step 508, the method 500 queries if the “ServletResponce.setLocale( )” API parameter contains information. This API is known in the art and was developed by Sun Microsystems. The use of the “ServletResponse.set Locale( )” API is arbitrary and may contain locale information. If not, the method 500 proceeds to step 510 where both the character set and JVM converter associated with the HTTP response is then set to ISO-8859-1 in accordance with the HTTP protocol standards. If so, the method 500 proceeds to step 512 where the method 500 maps the IANA character set 204 associated with the locale information 202 illustrated in FIG. 2, with the locale information contained in the ServletResponse.setLocale( ) API. At step 514, the method queries if the mapping was successful. If not, the method 500 proceeds to step 510.

If the mapping was successful, the method 500 proceeds to step 518 to access the JVM converter 302 information illustrated in FIG. 3 to find a JVM converter 302 match with the IANA character set 204 matched in step 512. At step 516, the method 500 queries if a match was found. If so, the method 500 proceeds to step 520 where the JVM converter 302 is set to the matched JVM converter 302. If not, the method proceeds to step 522 where the JVM converter is set to the IANA character set.

As an illustration, once an appropriate code-set and JVM converter gets associated with an HTTP response, the computer program 110 will convert the HTTP response from UCS-2 to the IANA character set using the selected JVM converter. If the ‘Content-Type’ header is missing from the HTTP response, the computer program 110 will generate an HTTP Content-Type header containing the selected IANA charset name.

It is understood that references herein to specific protocols (such as HTTP), standards (such as the IANA character set and UCS-2) and APIs (such as ServletResponse.setLocale( )) are merely illustrative. Persons skilled in the art will recognize that other embodiments are contemplated using other standards, protocols, API machines and the like. As such, the embodiments are not limited to the Internet and other Wide Area Networks (WANs) or Local Area Networks (LANs) may be used.

A further description of code set selection mechanisms are described with reference to “Unicode and IBM WebSphere”, Kentaro Nijo and Debasish Banerjee, pp 1-13, submitted to the 19^{th} International Unicode Conference, San Jose, Calif., on Jun. 29, 2001, which is hereby incorporated by reference and which is filed herewith in an Information Disclosure Statement.

While the foregoing is directed to embodiments of the present invention, other and further embodiments of the invention may be devised without departing from the basic scope thereof, and the scope thereof is determined by the claims that follow.

What is claimed is:

1. A method of determining character sets of client-server communications, comprising at least one of:
(a) selecting a character set for a client request from a client to a server, the selecting comprising:
determining whether the client request includes a request character set designation;
if the client request does not include the request character set designation, retrieving locale information contained in the client request; and
associating the locale information with the request character set designation using mapping data located on the server; and
(b) selecting a response character set for a server response from the server to the client, the selecting comprising:
determining whether the server response includes a response character set designation;
if the server response does not include the response character set designation, retrieving locale information contained in the server response; and
associating the locale information contained in the server response with the response character set designation using the mapping data.

2. The method of claim 1, wherein the client request and the server response are formatted as hypertext transfer protocol (HTTP).

3. The method of claim 1, wherein associating comprises accessing a character set lookup table that maps the locale information to the request character set designation and response request character set designation, respectively.

4. The method of claim 1, further comprising associating the request character set designation with a code-set converter designation by accessing a converter lookup table which maps the code-set converter designation with the request character set designation.

5. The method of claim 1, wherein the locale information contains a cultural language preference identifier.

6. The method of claim 1, wherein the character set designations contain an IANA character set parameter.

7. The method of claim 1, further comprising associating the request character set designation with a code-set converter designation.

8. The method of claim 7, wherein the code-set converter designation is contained in a lookup table and is mapped with response character set designation.

9. The method of claim 7, wherein the code-set converter designation is indicative of user specific implementations of character sets.

10. The method of claim 1, further comprising converting the client request into Unicode characters.

11. The method of claim 10, further comprising converting the response from Unicode characters to the character set associated with the locale information.

12. A server computer system connected to at least one client computer, the server computer system comprising a memory containing a code-set program and at least one processor, wherein the processor, when executing the code-set program, is configured to:
determine if a request header of a client request from the at least one client computer designates a character set;
if not, retrieve locale information from the client request; and
associate the locale information with a character set.

13. The system of claim 12, wherein the processor is further configured to associate the character set with a code-set converter.

14. The system of claim 12, wherein the locale information contains a language identifier.

15. The system of claim 12, wherein the code-set converter is a JVM code-set converter.

16. A computer readable medium containing at least a code-set program which, when executed by a server computer, performs operations comprising at least one of:
(a) selecting a character set for a client request from a client computer to the server computer, the selecting comprising:
determining whether the client request includes a request character set designation;
if the client request does not include the request character set designation, retrieving locale information contained in the client request; and
associating the locale information with the request character set designation using mapping data located on the server; and
(b) selecting a response character set for a server response from the server to the client, the selecting comprising:
determining whether the server response includes a response character set designation;
if the server response does not include the response character set designation, retrieving locale information contained in the server response; and
associating the locale information contained in the server response with the response character set designation using the mapping data.

17. The computer readable medium of claim 16, wherein the client request and the server response are formatted as hypertext transfer protocol (HTTP).

18. The computer readable medium of claim 16, wherein associating comprises accessing a character set lookup table that maps the locale information to the request character set designation and response request character set designation, respectively.

19. The computer readable medium of claim 16, further comprising associating the request character set designation with a code-set converter designation by accessing a converter lookup table which maps the code-set converter designation with the request character set designation.

20. The computer readable medium of claim 16, wherein the locale information contains a cultural language preference identifier.

21. The computer readable medium of claim 16, wherein the character set designations contain an IANA character set parameter.

22. The computer readable medium of claim 16, further comprising associating the request character set designation with a code-set converter designation.

23. The computer readable medium of claim 22, wherein the code-set converter designation is contained in a lookup table and is mapped with response character set designation.

24. The computer readable medium of claim 22, wherein the code-set converter designation is indicative of user specific implementations of character sets.

25. The computer readable medium of claim 24, wherein the code-set converter designation is contained in a Java Virtual Machine (JVM) code-set converter.

26. The computer readable medium of claim 16, further comprising converting the client request into Unicode characters.

27. The computer readable medium of claim 26, further comprising converting the response from Unicode characters to the character set associated with the locale information.
